(19) United States
(12) Patent Application Publication
(10) Pub. No.: US 2025/0212117 A1
(43) Pub. Date: Jun. 26, 2025

(54) System For Charging Ambient Power Devices

(71) Applicant: Cisco Technology, Inc., San Jose, CA (US)

(72) Inventors: Robert Barton, VANCOUVER (CA); Juan Carlos Zuniga, MONTREAL (CA); Jerome Henry, Pittsboro, NC (US); Indermeet Gandhi, San Jose, CA (US); Leo Caldarola, Ecublens (CH)

(21) Appl. No.: 18/597,885

(22) Filed: Mar. 6, 2024

Related U.S. Application Data
(60) Provisional application No. 63/614,357, filed on Dec. 22, 2023.

(51) Int. Cl. H04W 52/02

(52) U.S. Cl. CPC H04W 52/0216

(57) ABSTRACT

Devices, networks, systems, methods, and processes for scheduling transmissions from a plurality of ambient power devices are described herein. An Access Point (AP) may determine device profile data of an ambient power device. The AP can generate a Target Wake Time (TWT) schedule based on the device profile data. The TWT schedule may include service period and service interval. The ambient power device can function in a semi-sleep mode during the service interval and can generate or process data and store the data. The ambient power device may switch to a transmission mode during the service period. In the transmission mode, the ambient power device can generate and transmit one or more uplink frames to the AP. The ambient power device may also receive one or more charging frames. The ambient power device can charge an energy storage based on the one or more charging frames.

### CROSS-REFERENCE TO RELATED APPLICATION

This application claims the benefit of U.S. Provisional Patent Application No. 63/614,357, filed Dec. 22, 2023, which is incorporated by reference herein in its entirety.

The present disclosure relates to wireless communication. More particularly, the present disclosure relates to communication with ambient power devices.

### BACKGROUND

Ambient power devices can be of various types. The ambient power devices can be powered by one or more energy sources such as, but not limited to, radio waves, light, motion, heat, or any such ambient energy sources. Some ambient power devices may be passive devices that do not include any energy storage. Such passive devices merely reflect energy, such as Radio Frequency (RF) waves, received in real-time or in near-real time. Some other ambient power devices can be active devices that can include energy storages such as capacitors or batteries to store the energy. Such active devices can delay transmission of data by utilizing the stored energy.

However, there exist multiple challenges in recharging the energy storages of the ambient power devices. The ambient energy sources may not be adequately available to fully recharge the energy storages. Therefore, the ambient power devices may or may not have a required charge necessary for generating the data or transmitting the data. In some applications, the ambient power devices can be sensors such as temperature, pressure, humidity, or health sensors etc. If the energy storages of these sensors are not recharged, the sensors may not have the required charge to measure physical parameters such as temperature, pressure, or humidity values etc. This may lead to failure in generation and transmission of the data from the ambient power devices.

Moreover, the energy storages of the ambient power devices are of very limited capacity, and hence, may get discharged quickly. As a result, the energy storages of the ambient power devices must be frequently recharged to avoid the failure in generation and transmission of the data. However, there exists no technique to predict a time of transmission of the data and recharge the energy storages of the ambient power devices just in time.

Therefore, there is a need for a technique to effectively recharge the energy storages of the ambient power devices and accordingly schedule the transmission of the data from the ambient power devices.

### SUMMARY OF THE DISCLOSURE

Systems and methods for charging the ambient power devices and scheduling transmissions from the ambient power devices in accordance with embodiments of the disclosure are described herein. In some embodiments, a device includes a processor, and a memory communicatively coupled to the processor, wherein the memory includes a transmission scheduling logic. In some embodiments, a transmission scheduling logic is configured to detect a plurality of ambient power devices, determine device profile data associated with an ambient power device of the plurality of ambient power devices, generate schedule data based on the device profile data, and transmit the schedule data to the ambient power device.

In some embodiments, the schedule data is indicative of a Target Wake Time (TWT) schedule associated with the ambient power device.

In some embodiments, the device profile data is indicative of at least one of an energy storage capacity of the ambient power device, or a transmission duration associated with the ambient power device.

In some embodiments, the transmission scheduling logic is further configured to determine a service period of the TWT schedule based on the transmission duration, and a service interval of the TWT schedule based on the energy storage capacity.

In some embodiments, the ambient power device operates in a semi-sleep mode during the service interval and in a transmission mode during the service period.

In some embodiments, the transmission scheduling logic is further configured to generate at least one control frame based on the schedule data, and transmit the at least one control frame to the ambient power device during the service period on a first Radio Frequency (RF) channel.

In some embodiments, the transmission scheduling logic is further configured to receive, on a second RF channel, at least one uplink frame indicative of uplink data from the ambient power device.

In some embodiments, an energy storage of the ambient power device is recharged based on the at least one control frame.

In some embodiments, the energy storage is utilized to generate the uplink data.

In some embodiments, the transmission scheduling logic is further configured to identify a wireless device in communication with the ambient power device, and transmit the schedule data to the wireless device.

In some embodiments, the wireless device operates in a power saving mode during the service interval and in an operational mode during the service period.

In some embodiments, the transmission scheduling logic is further configured to receive, from the wireless device, at least one uplink frame associated with the ambient power device during the service period.

In some embodiments, a method includes detecting a plurality of ambient power devices, determining device profile data associated with a set of ambient power devices of the plurality of ambient power devices, generating schedule data based on the device profile data, and transmitting the schedule data to the set of ambient power devices.

In some embodiments, the schedule data is indicative of a broadcast Target Wake Time (TWT) schedule associated with the set of ambient power devices.

In some embodiments, the device profile data is indicative of at least one of one or more energy storage capacities of the set of ambient power devices, or one or more transmission durations associated with the set of ambient power devices.

In some embodiments, a method further includes determining a service period of the broadcast TWT schedule based on the one or more transmission durations, and a service interval of the broadcast TWT schedule based on the one or more energy storage capacities.

In some embodiments, a method further includes charging the set of ambient power devices during the service period.

In some embodiments, a transmission scheduling logic is configured to receive schedule data indicative of a service period and a service interval, receive, on a first wireless channel, a charging frame during the service period, recharge an energy storage based on the charging frame, and transmit, on a second wireless channel, an uplink frame during the service period.

In some embodiments, the transmission scheduling logic is further configured to operate in a semi-sleep mode during the service interval and operate in a transmission mode during the service period.

In some embodiments, the transmission scheduling logic is further configured to generate uplink data associated with the uplink frame during the service interval.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a conceptual illustration of a wireless communication network, in accordance with various embodiments of the disclosure;

FIG. 2 is a conceptual illustration of a wireless communication network, in accordance with various embodiments of the disclosure;

FIG. 3 is a conceptual network diagram of various environments that a transmission scheduler may operate on a plurality of network devices, in accordance with various embodiments of the disclosure;

FIG. 4 is a flowchart depicting a process for generating schedule data associated with one or more ambient power devices, in accordance with various embodiments of the disclosure;

FIG. 5 is a flowchart depicting a process for generating a service period and a service interval associated with a Target Wake Time (TWT) schedule, in accordance with various embodiments of the disclosure;

FIG. 6 is a flowchart depicting a process for transmission and reception of frames, in accordance with various embodiments of the disclosure;

FIG. 7 is a flowchart depicting a process for aligning a wireless device to a Target Wake Time (TWT) schedule, in accordance with various embodiments of the disclosure; and

FIG. 8 is a conceptual block diagram of a device suitable for configuration with a transmission scheduling logic, in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein that schedule transmissions from multiple ambient power devices. A communication network may comprise an Access Point (AP) and one or more ambient power devices. The ambient power devices can be in communication with the AP by way of one or more Radio Frequency (RF) channels. The RF channels may include multiple bands of frequencies. In some embodiments, for example, the bands of frequencies may include Wi-Fi bands such as but not limited to 2.4 GHZ, 5 GHz, or 6 GHz. Some more examples can include millimeter-wave (mmWave) bands. Additional examples can include Sub-1 GHz band frequencies. The ambient power devices can be powered by one or more ambient energy sources such as, but not limited to, radio waves, light, motion, heat, or any such ambient energy sources. Some ambient power devices may be passive devices that do not include any energy storage. Such passive devices merely reflect RF waves, received in real-time or in near-real time. Some other ambient power devices can be active devices that can include energy storages such as but not limited to capacitors or batteries to store the energy. These energy storages can be recharged by utilizing one or more of the ambient energy sources.

In many embodiments, in the communication network, the ambient power devices can be connected to the AP. The ambient power devices may be managed by the AP. In that, the AP can recharge the ambient power devices, i.e., the AP can recharge the energy storages in the ambient power devices. The AP may also schedule uplink transmissions of the ambient power devices. In some embodiments, energy storage capacities of the ambient power devices can be limited. Therefore, to save power, the ambient power devices may operate in low power modes or power saving modes such as but not limited to a sleep mode or a semi-sleep mode. In certain embodiments, for example, the ambient power devices can be sensors such as but not limited to temperature, pressure, humidity, or health sensors etc. In the semi-sleep mode, the ambient power devices may collect or generate uplink data by measuring one or more physical parameters such as but not limited to temperature, pressure, or humidity values etc. The ambient power devices can utilize the energy in the energy storages to measure the physical parameters and generate the uplink data and also to delay the transmission of the uplink data. Thereafter, the ambient power devices can wake up to enter a transmission mode to transmit the uplink data by way of one or more uplink frames to the AP. Operating the ambient power devices in the semi-sleep mode may reduce power consumption of the ambient power devices. In more embodiments, the AP may allocate network resources to the ambient power devices, manage RF connections with the ambient power devices, and schedule uplink transmissions from the ambient power devices.

In a number of embodiments, the AP can detect the ambient power devices. In some embodiments, the AP can utilize passive scanning, beacon frames, probe requests and responses, analysis of backscatter signals, etc. to detect the ambient power devices. The ambient power devices may share device profile data with the AP during association with the AP. In some embodiments, for example, the ambient power devices can share the device profile data with the AP periodically, i.e., at predetermined time intervals. In some embodiments, for example, the ambient power devices can share the device profile data with the AP by way of a Manufacturer Usage Description (MUD) Uniform Resource Locator (URL) or MUD data.

In many further embodiments, the device profile data may include, but is not limited to, transmission profile, charging profile, or identification information. In numerous embodiments, examples of the transmission profile may include but are not limited to information about types of frames, for e.g., keepalive frames, scheduled updates, or triggered alarms, etc. In many more embodiments, the transmission profile can include information about transmission, for e.g., transmission type, frame sizes, or transmission intervals, etc. In still more embodiments, examples of the charging profile may include, but are not limited to, power requirements of the ambient power devices, i.e., a level of charge required by the ambient power devices to transmit one or more frames, an energy storage capacity of the ambient power devices, charging time for accumulating the energy storage capacity of the ambient power devices, or energy harvesting capacities of the ambient power devices etc. In many further embodiments, the device profile data may include the identification information, such as but not limited to, device identifiers of the ambient power devices or addresses of the ambient power devices, etc. In some more embodiments, the AP can retrieve or determine the device profile data in many more ways. In numerous embodiments, for example, the AP may determine the device profile data by employing a combination of one or more of: network scanning, protocol analysis, physical inspection, and database lookup techniques.

In various embodiments, the AP can receive the device profile data and can determine, based on the device profile data, an energy capacity associated with the energy storages of the ambient power devices. In certain embodiments, for example, the energy capacities may include a maximum capacity of the capacitor or the battery in the ambient power devices. The energy capacity can also be indicative of a time required to fully charge the energy storages of the ambient power devices. In more embodiments, for example, different ambient power devices can possess different energy storage capacities, and hence, may also require different times for fully recharging the energy storages. The energy storage capacities may also be indicative of a minimum or required charge level to perform transmission of the one or more uplink frames. The energy storage capacity can also be indicative of a time taken to discharge the energy storage capacity, i.e., the time taken to discharge the capacitor or the battery of the ambient power devices. The AP can also determine transmission durations associated with the ambient power devices based on the device profile data. The transmission durations associated with the ambient power device can be indicative of a time required by the ambient power device to transmit the one or more uplink frames. The transmission durations may also be indicative of one or more of: a duration of the one or more uplink frames, priority of the uplink frames, number of the uplink frames to be transmitted, etc. The transmission durations can also be indicative of a volume of the data stored in a buffer of the ambient power devices that is scheduled to be transmitted by way of the one or more uplink frames.

In additional embodiments, the ambient power device can operate in two modes, viz, a semi-sleep mode and a transmission mode. The ambient power device may operate in the semi-sleep mode to conserve energy. In the semi-sleep mode, the ambient power device can measure the physical parameters by utilizing the sensors and generate the uplink data. In the transmission mode, the ambient power device may transmit the one or more uplink frames indicative of the uplink data. In the transmission mode, the ambient power device can also receive one or more charging frames from the AP and utilize the charging frames to recharge the energy storage. In some embodiments, the ambient power device can wake up to enter the transmission mode periodically, i.e., after predetermined period of time. In certain embodiments, the ambient power device may be triggered by the AP to enter the transmission mode. The ambient power device can utilize a frequency offset for the uplink transmission. In that, the ambient power device may receive the charging frames from the AP on a first RF channel with a first frequency and may transmit the uplink frames to the AP on a second RF channel with a second frequency. In some more embodiments, the first and second RF channels may be assigned by the AP. Hence, the ambient power device can recharge the energy storage and transmit the uplink data simultaneously.

In further embodiments, the AP can generate a Target Wake Time (TWT) schedule based on the device profile data associated with the ambient power device. The TWT schedule may be utilized to switch the ambient power device between the semi-sleep mode and the transmission mode, for example. Operating the ambient power device based on the TWT schedule can help in reducing the power consumption of the ambient power device. The AP may communicate the TWT schedule to the ambient power device by transmitting schedule data to the ambient power device. The schedule data may be indicative of the TWT schedule. The schedule data can be transmitted by way of one or more control frames, management frames, downlink frames, trigger frames, or charging frames, etc. for example. In some embodiments, the AP can group one or more ambient power devices, i.e., a set of ambient power devices. The one or more ambient power devices may be grouped based on location, power consumption, energy storage capacities, functions, or the device profiles. The AP can generate a broadcast TWT schedule associated with the group of ambient power devices. The AP may transmit the schedule data indicative of the broadcast TWT schedule to the group of ambient power devices. By way of the broadcast TWT schedule, one or more of: recharging times, transmission times, semi-sleep modes, or transmission modes of the one or more ambient power devices in the group of ambient power devices may be aligned by the AP.

In many more embodiments, the TWT schedule may include a service period and a service interval. The AP can determine the service period based on the transmission duration. In some embodiments, the AP may determine the service period based on the time required by the ambient power device to transmit the uplink frames and/or the time required to recharge the energy storage of the ambient power device. The AP can determine the service period such that the ambient power device can operate in the transmission mode during the service period. In more embodiments, the ambient power device may wake up from the semi-sleep mode and enter the transmission mode at the start of the service period. In numerous embodiments, the AP can detect the start of the service period and can transmit the one or more charging frames and/or one or more trigger frames to the ambient power device at the start of the service period. The AP may transmit the charging frames or the trigger frames by way of a beamformed signal. In that, the AP can utilize beamforming for focusing the beamformed signal on the ambient power device. The AP may focus the beamformed signal for just long enough to fully recharge the energy storage of the ambient power device.

In many further embodiments, after the energy storage of the ambient power device is fully charged, the ambient power device can switch to the semi-sleep mode. The ambient power device can continue to operate in the semi-sleep mode through the service interval. The AP may determine the service interval based on the energy storage capacity. In certain embodiments, the AP can determine the service interval based on the time required by the ambient power device to measure the physical parameters, generate the uplink data, and/or a battery life of the ambient power device. The AP can determine the service interval such that the ambient power device can operate in the semi-sleep mode during the service interval. The ambient power device may continue to generate and/or store the uplink data until the next service period starts.

In many additional embodiments, the AP may optimize the service period and/or the service interval based on one or more of: change in network conditions, wear and tear in the ambient power device, or usage/activity of the ambient power device, etc. The AP can thereby modify the TWT schedule or generate a new TWT schedule. The AP may transmit the modified TWT schedule or the new TWT schedule to the ambient power device. Since each ambient power device may have different energy storage capacity and transmission requirements, each ambient power device can have a different TWT schedule. In case of the broadcast TWT schedule, all the ambient power devices in the group may be assigned the broadcast TWT schedule. In that case, the ambient power devices in the group can utilize one or more multiplexing techniques for simultaneous uplink transmissions. In some embodiments, the AP can also utilize Machine Learning (ML) techniques to further optimize the TWT schedule. The AP may also continuously monitor an energy consumption and charging status of each ambient power device to dynamically adjust the timing of the semi-sleep mode, transmission mode, or recharging intervals etc.

In many further embodiments, the AP can extend the TWT schedule to one or more wireless devices in communication with the ambient power devices. The wireless device may function as a relay, proxy, or buddy for one or more ambient power devices or for the group of ambient power devices. The AP can transmit the TWT schedule to the wireless device. Therefore, the wireless device can operate in a low power mode or a power saving mode during the service interval and can operate as the relay, proxy, energizer, receiver, or buddy device etc. during the service period. The wireless device can transmit the charging frames or the trigger frames to the ambient power device at the start of the service period. The wireless device may receive the uplink frames from the ambient power devices and relay the uplink frames to the AP. In some more embodiments, the TWT schedule, i.e., the service periods and the service intervals of the wireless device and the ambient power devices may be aligned.

Advantageously, utilizing TWT can maximize energy efficiency of the ambient power devices. The AP can also utilize the ML techniques to further optimize the TWT schedule. The charging and transmission scheduling technique of the present disclosure may provide efficient energy utilization and reliable operation within the network. The AP can synchronize the uplink transmissions and recharge the energy storages by employing frequency shift techniques to avoid interference between the uplink frames and the charging frames. The transmission scheduler of the present disclosure also can also avoid or minimize collisions, and hence, prevent loss of data. Therefore, utilizing the TWT schedule to operate the ambient power devices in the semi-sleep mode can facilitate optimized use of the network resources and reduce contention for wireless medium, and thereby improve efficiency and throughput of the network.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.”. Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C #, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.”. An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

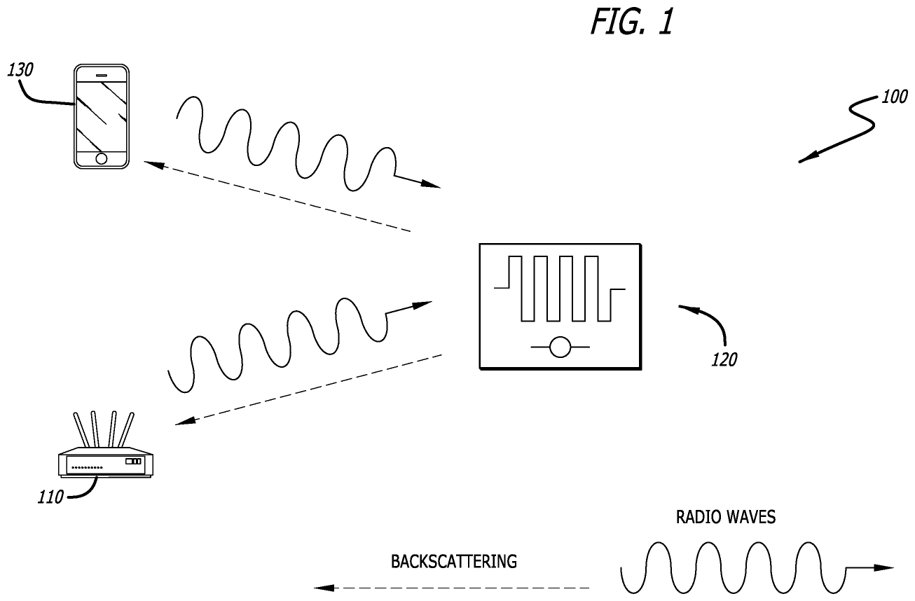

Referring to FIG. 1, a conceptual illustration of a wireless communication network 100, in accordance with various embodiments of the disclosure is shown. In many embodiments, the wireless communication network 100 can include an Access Point (AP) 110, an ambient power device 120, and a wireless device 130. The ambient power device 120 may be powered by one or more energy sources such as, but not limited to, radio waves, light, motion, heat, or any such ambient energy sources. The ambient power device 120 may be an active device, i.e., with an energy storage such as a battery or a capacitor etc. or the ambient power device 120 can be a passive device. The ambient power device 120 can receive one or more Radio Frequency (RF) signals. The ambient power device 120 may backscatter the RF signals. In some embodiments, the ambient power device 120 can modulate and backscatter incident RF signals. In certain embodiments, the ambient power device 120 can be in communication with the AP 110 by utilizing Wi-Fi bands such as but not limited to 2.4 GHz, 5 GHz, or 6 GHz. Some more examples can include millimeter-wave (mmWave) bands. Additional examples can include Sub-1 GHz band frequencies. Examples of the backscatter communication between the ambient power device 120, the AP 110, and the wireless device 130 include but are not limited to monostatic backscatter, bistatic backscatter, and ambient backscatter. The wireless device 130 may function as a receiver for backscatter transmission from the ambient power device 120. Examples of the wireless device 130 include but are not limited to smartphone, tablet, computer, an RF Identification (RFID) tag reader, etc. In certain embodiments, for example, the ambient power device 120 may be associated with a consumer electronic device or an Internet of Things (IoT) enabled device.

In a number of embodiments, the ambient power device 120 may be managed by the AP 110. In that, the AP 110 can recharge the ambient power device 120, i.e., the AP 110 can recharge the energy storage in the ambient power device 120. The AP 110 may also schedule uplink transmissions of the ambient power device 120. In some embodiments, the energy storage capacity of the ambient power device 120 can be limited. Therefore, to save power, the ambient power device 120 may operate in low power modes such as but not limited to sleep mode or semi-sleep mode. In certain embodiments, for example, the ambient power device 120 can be a sensor such as but not limited to temperature, pressure, humidity, or health sensors etc. In the semi-sleep mode, the ambient power device 120 may collect or generate uplink data by measuring one or more physical parameters such as but not limited to temperature, pressure, or humidity values etc. The ambient power device 120 can utilize the energy storage to measure the physical parameters and generate the uplink data and also to delay the transmission of the uplink data. Thereafter, the ambient power device 120 can wake up to enter a transmission mode to transmit the uplink data by way of one or more uplink frames to the AP 110. Operating the ambient power device 120 in the semi-sleep mode may reduce power consumption of the ambient power device 120. In more embodiments, the AP 110 may allocate network resources to the ambient power device 120, manage RF connections with the ambient power device 120, and schedule uplink transmissions from the ambient power device 120.

In various embodiments, the AP 110 can receive the device profile data associated with the ambient power device 120. The AP 110 can determine the energy capacity associated with the energy storage of the ambient power device 120. The AP 110 can determine a transmission duration associated with the ambient power device 120. The AP 110 can generate a Target Wake Time (TWT) schedule based on the device profile data associated with ambient power device 120. The TWT schedule may be utilized to switch the ambient power device 120 between the semi-sleep mode and the transmission mode, for example. The AP 110 may communicate the TWT schedule to the ambient power device 120 by transmitting schedule data to the ambient power device 120.

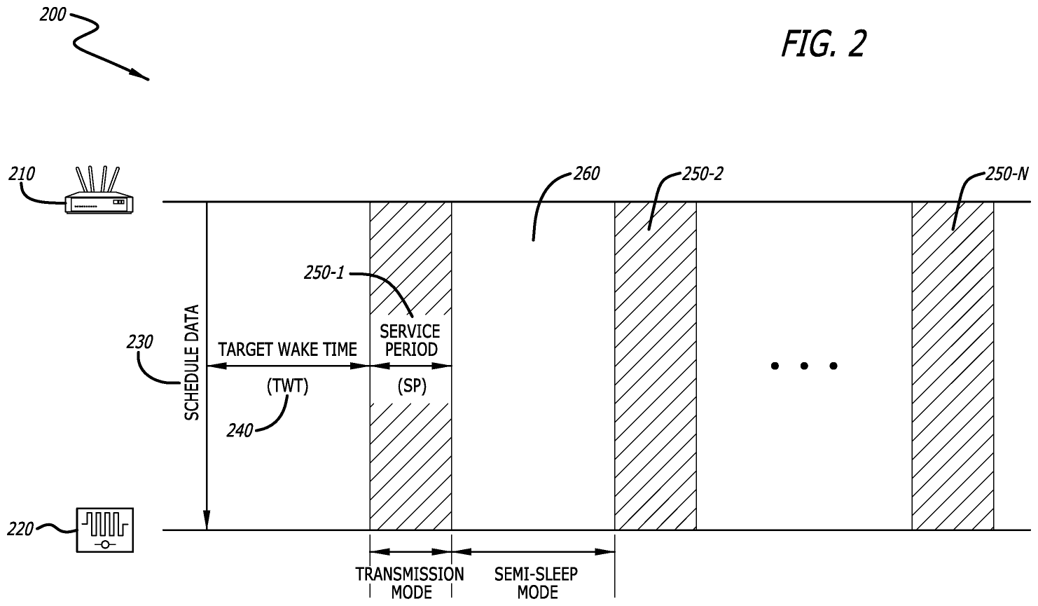

Although a specific embodiment for the wireless communication network 100 for carrying out the various steps, processes, methods, and operations described herein is discussed with respect to FIG. 1, any of a variety of systems and/or processes may be utilized in accordance with embodiments of the disclosure. For example, the AP 110 may dynamically switch the ambient power device between the semi-sleep mode and the transmission mode. The elements depicted in FIG. 1 may also be interchangeable with other elements of FIGS. 2-8 as required to realize a particularly desired embodiment.

Referring to FIG. 2, a conceptual illustration of a wireless communication network 200, in accordance with various embodiments of the disclosure is shown. In many embodiments, the wireless communication network 200 can include the AP 210 and an ambient power device 220. The AP 210 can receive the device profile data associated with the ambient power device 220. The device profile data may include the energy capacity associated with the energy storage of the ambient power device 220. The device profile data may also include the transmission duration associated with the energy storage of the ambient power device 220.

In a number of embodiments, the AP 210 can determine the TWT schedule based on the device profile data. The AP 210 can transmit to the ambient power device 220, the schedule data 230 indicative of the TWT schedule. The TWT schedule may include one or more service periods 250 including a first service period 250-1 through a last service period 250-N. The TWT schedule can also indicate a TWT 240 after which the first service period 250-1 starts. The ambient power device 220 can wake up and begin the uplink transmission at the start of the first service period 250-1. The first service period 250-1 may be separated from a second service period 250-2 by a service interval 260. The ambient power device 220 can operate in the semi-sleep mode during the service interval 260 and in the transmission mode during the one or more service periods 250.

In various embodiments, the AP 210 can determine the service period based on the transmission duration. In some embodiments, the AP 210 may determine the service period based on a time required by the ambient power device 220 to transmit the uplink frames and/or recharge the energy storage. The AP 210 can determine the service period such that the ambient power device 220 can operate in the transmission mode during the service period. In more embodiments, the ambient power device 220 may wake up from the semi-sleep mode and enter the transmission mode at the start of the service period. In numerous embodiments, the AP 210 can detect the start of the service period and can transmit the one or more charging frames and/or one or more trigger frames to the ambient power device 220 at the start of the service period. The AP 210 may transmit the charging frames or the trigger frames by way of a beamformed signal. In that, the AP 210 can utilize beamforming for focusing the beamformed signal on the ambient power device 220. The AP 210 may focus the beamformed signal for just long enough to fully recharge the energy storage of the ambient power device 220.

In additional embodiments, after the energy storage of the ambient power device 220 is fully charged, the ambient power device 220 can switch to the semi-sleep mode. The ambient power device 220 can continue to operate in the semi-sleep mode through the service interval. The AP 210 may determine the service interval based on the energy storage capacity. In certain embodiments, the AP 210 can determine the service interval based on a time required by the ambient power device 220 to measure the physical parameters, generate the uplink data, and/or a battery life of the ambient power device 220. The AP 210 can determine the service interval such that the ambient power device 220 can operate in the semi-sleep mode during the service interval. The ambient power device 220 may continue to generate and/or store the uplink data until the next service period starts.

Although a specific embodiment for the wireless communication network 200 for carrying out the various steps, processes, methods, and operations described herein is discussed with respect to FIG. 2, any of a variety of systems and/or processes may be utilized in accordance with embodiments of the disclosure. For example, the AP 210 may dynamically modify the TWT schedule for the ambient power device 220. The elements depicted in FIG. 2 may also be interchangeable with other elements of FIG. 1 and FIGS. 3-8 as required to realize a particularly desired embodiment.

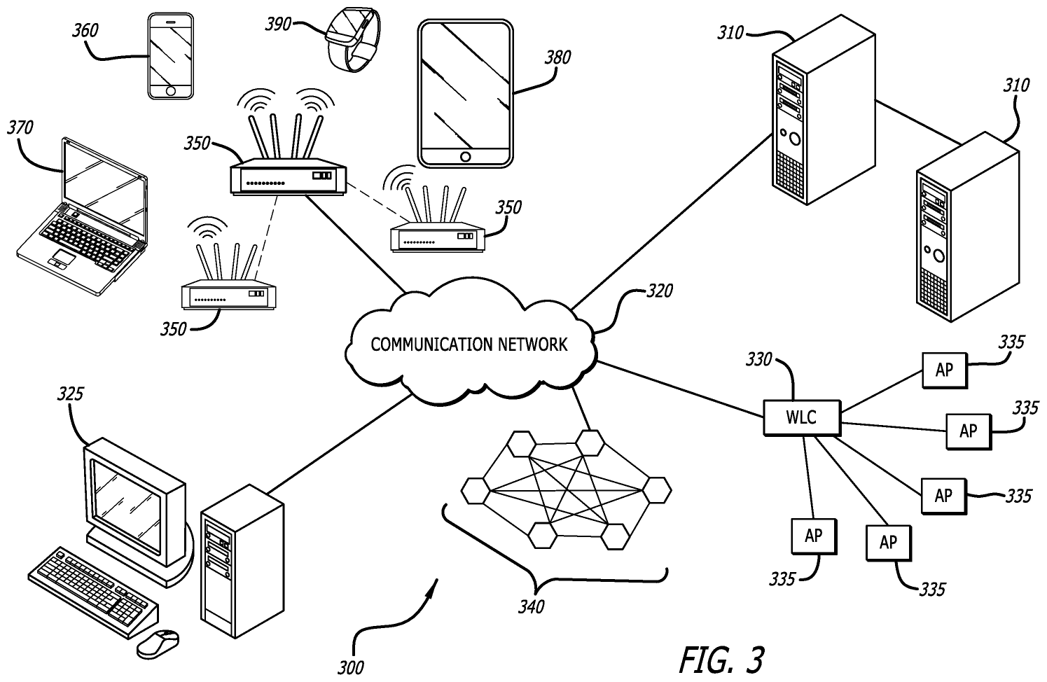

Referring to FIG. 3, a conceptual network diagram 300 of various environments that a transmission scheduler may operate on a plurality of network devices, in accordance with various embodiments of the disclosure is shown. Those skilled in the art will recognize that the transmission scheduler can be comprised of various hardware and/or software deployments and can be configured in a variety of ways. In many embodiments, the transmission scheduler can be configured as a standalone device, exist as a logic in another network device, be distributed among various network devices operating in tandem, or remotely operated as part of a cloud-based network management tool. In further embodiments, one or more servers 310 can be configured with or otherwise operate the transmission scheduler. In many embodiments, the transmission scheduler may operate on one or more servers 310 connected to a communication network 320. The communication network 320 can include wired networks or wireless networks. In many embodiments, the communication network 320 may be a Wi-Fi network operating on various frequency bands, such as, 2.4 GHz, 5 GHZ, or 6 GHz. In further embodiments, the transmission scheduler operating on the servers 310 can facilitate in generating the TWT schedules for the ambient power devices and scheduling transmissions from the ambient power devices. The transmission scheduler can be provided as a cloud-based service that can service remote networks, such as, but not limited to a deployed network 340. In many embodiments, the transmission scheduler can be a logic that generates the TWT schedules for the ambient power devices.

However, in additional embodiments, the transmission scheduler may be operated as a distributed logic across multiple network devices. In the embodiment depicted in FIG. 3, a plurality of APs 350 can operate as the transmission scheduler in a distributed manner or may have one specific device operate as the transmission scheduler for all of the neighboring or sibling APs 350. The APs 350 facilitate Wi-Fi connections for various electronic devices, such as but not limited to mobile computing devices including laptop computers 370, cellular phones 360, portable tablet computers 380 and wearable computing devices 390.

In further embodiments, the transmission scheduler may be integrated within another network device. In the embodiment depicted in FIG. 3, a wireless LAN controller (WLC) 330 may have an integrated transmission scheduler that the WLC 330 can use to manage the uplink transmissions within the various APs 335 that the WLC 330 is connected to, either wired or wirelessly. In still more embodiments, a personal computer 325 may be utilized to access and/or manage various aspects of the transmission scheduler, either remotely or within the network itself. In the embodiment depicted in FIG. 3, the personal computer 325 communicates over the communication network 320 and can access the transmission scheduler of the servers 310, or the network APs 350, or the WLC 330.

Although a specific embodiment for various environments that the transmission scheduler may operate on a plurality of network devices suitable for carrying out the various steps, processes, methods, and operations described herein is discussed with respect to FIG. 3, any of a variety of systems and/or processes may be utilized in accordance with embodiments of the disclosure. In many non-limiting examples, the transmission scheduler may be provided as a device or software separate from the network devices or the transmission scheduler may be integrated into the network devices. The elements depicted in FIG. 3 may also be interchangeable with other elements of FIGS. 1-2 and 4-8 as required to realize a particularly desired embodiment.

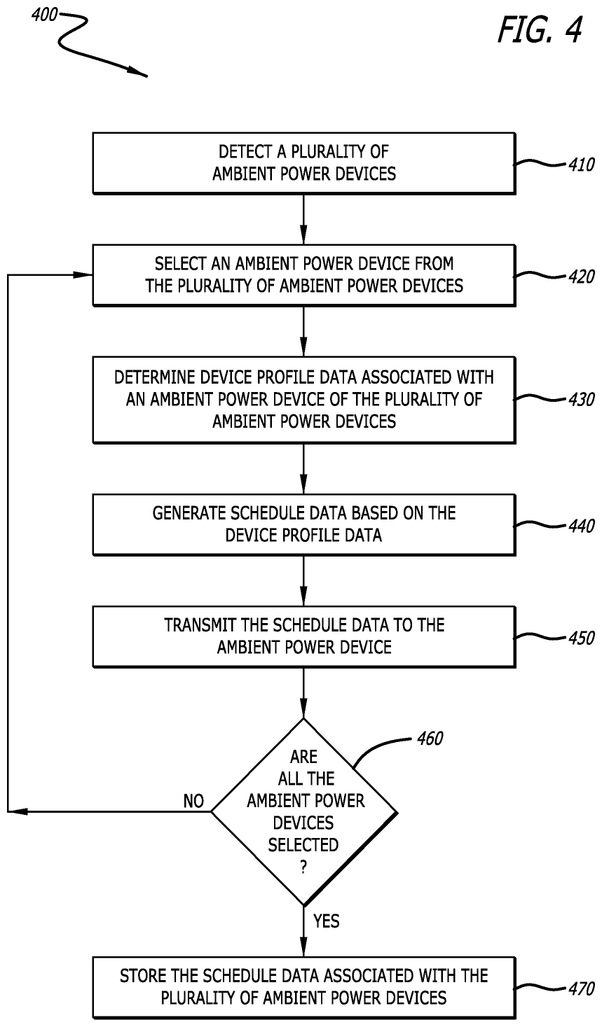

Referring now to FIG. 4, a flowchart depicting a process 400 for generating the schedule data associated with the ambient power devices, in accordance with various embodiments of the disclosure is shown. In many embodiments, the process 400 can detect a plurality of ambient power devices (block 410). In some embodiments, the process 400 may be implemented by the AP and/or the wireless device. In certain embodiments, the process 400 may utilize passive scanning, beacon frames, probe requests and responses, or analysis of backscatter signals, etc. to detect the ambient power devices. In more embodiments, the ambient power devices may share the device profile data with the process 400 during association with the AP. In some more embodiments, for example, the ambient power devices can share the device profile data with the process 400 by way of a Manufacturer Usage Description (MUD) Uniform Resource Locator (URL) or MUD data.

In a number of embodiments, the process 400 may select an ambient power device from the plurality of ambient power devices (block 420). In some embodiments, the process 400 can select one ambient power device at a time based on a predetermined order or based on random selection. In certain embodiments, the process 400 can select more than one ambient power devices simultaneously to transmit the uplink frames by utilizing one or more multiplexing techniques.

In various embodiments, the process 400 can determine the device profile data associated with an ambient power device of the plurality of ambient power devices (block 430). In some embodiments, the device profile data may include, but is not limited to, transmission profile, charging profile, or identification information. In numerous embodiments, examples of the transmission profile may include but are not limited to information about types of frames, for e.g., keepalive frames, scheduled updates, or triggered alarms, etc. In many more embodiments, the transmission profile can include information about transmission, for e.g., transmission type, frame sizes, or transmission intervals, etc. In still more embodiments, examples of the charging profile may include, but are not limited to, power requirements of the ambient power devices, i.e., a level of charge required by the ambient power devices to transmit one or more frames, an energy storage capacity of the ambient power devices, charging time for accumulating the energy storage capacity of the ambient power devices, or energy harvesting capacities of the ambient power devices etc. In many further embodiments, the device profile data may include the identification information, such as but not limited to, device identifiers of the ambient power devices or addresses of the ambient power devices, etc. In some more embodiments, the process 400 can retrieve or determine the device profile data in many more ways. In numerous embodiments, for example, the process 400 may determine the device profile data by employing a combination of one or more of: network scanning, protocol analysis, physical inspection, and database lookup techniques.

In additional embodiments, the process 400 may generate the schedule data based on the device profile data (block 440). In some embodiments, the process 400 can generate the TWT schedule based on the device profile data associated with the ambient power device. In certain embodiments, the TWT schedule may be utilized to switch the ambient power device between the semi-sleep mode and the transmission mode, for example. In more embodiments, operating the ambient power device based on the TWT schedule can help in reducing the power consumption of the ambient power device. In some more embodiments, the process 400 may communicate the TWT schedule to the ambient power device by transmitting the schedule data to the ambient power device.

In further embodiments, the process 400 can transmit the schedule data to the ambient power device (block 450). In some embodiments, the process 400 may transmit the data to the wireless device and the wireless device can switch between a low power mode such as sleep and a functional mode based on the schedule data. In certain embodiments, the wireless device may function as a relay, and hence, may be utilized to transmit the schedule data to the ambient power devices. In more embodiments, the TWT schedule can be the broadcast TWT schedule associated with the group of ambient power devices. In some more embodiments, the process 400 may also generate the schedule data indicative of a restricted TWT (rTWT) schedule for one or more ambient power devices. In numerous embodiments, the process 400 can generate a separate TWT schedule for each ambient power device.

In many more embodiments, the process 400 may check if all the ambient power devices are selected (block 460). If at block 460 the process 400 determines that all the ambient power devices have not been selected, in many more embodiments, the process 400 can select another ambient power device (block 420). In some embodiments, the process 400 may repeat the block 460 to ensure that all the ambient power devices have been selected and that the TWT schedules for all the ambient power devices have been generated and transmitted to the all the ambient power devices. In certain embodiments, the process 400 can continuously check for the ambient power devices that need to be recharged.

If at block 460 the process 400 determines that all the ambient power devices have been selected, in many additional embodiments, the process 400 can store the schedule data associated with the plurality of ambient power devices in a memory (block 470). In some embodiments, the stored schedule data can be utilized by one or more ML techniques to optimize the TWT schedules of the ambient power devices. In certain embodiments, the TWT schedules can be modified based on a change in topology of the ambient power devices, movement of the ambient power devices, states of operations of the ambient power devices, etc.

Although a specific embodiment for the process 400 for generating the schedule data associated with the ambient power devices for carrying out the various steps, processes, methods, and operations described herein is discussed with respect to FIG. 4, any of a variety of systems and/or processes may be utilized in accordance with embodiments of the disclosure. For example, the process 400 may dynamically modify existing TWT schedule or generate a new TWT schedule based on one or more dynamic changes in the wireless communication network. The elements depicted in FIG. 4 may also be interchangeable with other elements of FIGS. 1-3 and FIGS. 5-8 as required to realize a particularly desired embodiment.

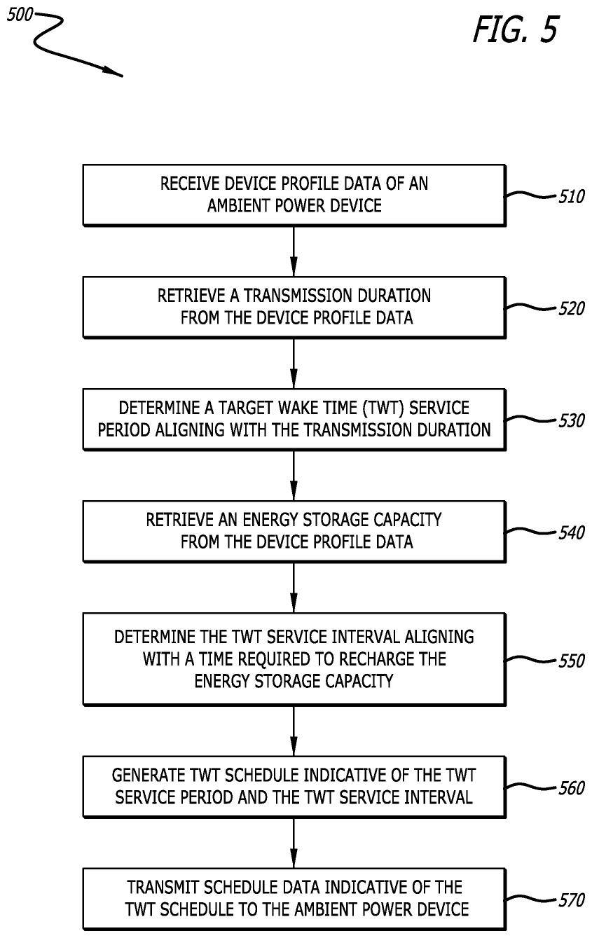

Referring now to FIG. 5, a flowchart depicting a process 500 for generating the service period and service interval associated with the TWT schedule, in accordance with various embodiments of the disclosure is shown. In many embodiments, the process 500 can receive the device profile data of the ambient power device (block 510). In some embodiments, the process 500 may receive the device profile data when the ambient power devices associate with the AP. In certain embodiments, for example, the ambient power devices can share the device profile data with the process 500 periodically, i.e., at predetermined time intervals. In more embodiments, for example, the ambient power devices can share the device profile data with the process 500 by way of the MUD URL or MUD data.

In a number of embodiments, the process 500 may retrieve the transmission duration from the device profile data (block 520). In some embodiments, the transmission duration associated with the ambient power device can be indicative of the time required by the ambient power device to transmit the one or more uplink frames. In certain embodiments, the transmission duration may also be indicative of one or more of: a duration of the one or more uplink frames, priority of the uplink frames, number of the uplink frames to be transmitted, etc. In more embodiments, the transmission duration can also be indicative of the uplink data stored in the buffer of the ambient power device that is scheduled to be transmitted by way of the one or more uplink frames.

In various embodiments, the process 500 can determine the TWT service period aligning with the transmission duration (block 530). In some embodiments, the process 500 can determine the service period based on the transmission duration. In certain embodiments, the process 500 may determine the service period based on a time required by the ambient power device to transmit the uplink frames and/or recharge the energy storage. In more embodiments, the process 500 can determine the service period such that the ambient power device can operate in the transmission mode during the service interval. In some more embodiments, the ambient power device may wake up from the semi-sleep mode and enter the transmission mode at the start of the service period. In numerous embodiments, the process 500 can detect the start of the service period and can transmit the one or more charging frames and/or one or more trigger frames to the ambient power device at the start of the service period. In many further embodiments, the process 500 may transmit the charging frames or the trigger frames by way of a beamformed signal. In that, in still more embodiments, the process 500 can utilize beamforming for focusing the beamformed signal on the ambient power device. In many additional embodiments, the process 500 may focus the beamformed signal for just long enough to fully recharge the energy storage of the ambient power device. In still further embodiments, after the energy storage of the ambient power device is fully charged, the ambient power device can switch to the semi-sleep mode.

In additional embodiments, the process 500 may retrieve the energy storage capacity from the device profile data (block 540). In some embodiments, for example, the energy storage capacity may include the maximum capacity of the capacitor or the battery in the ambient power device. In certain embodiments, the energy capacity can also be indicative of the time required to fully charge the energy storage of the ambient power device. In more embodiments, for example, different ambient power devices can possess different energy storage capacities, and hence, may also require different times for fully recharging the energy storages. In some more embodiments, the energy storage capacity may also be indicative of a minimum charge level or a required charge level to perform transmission of the one or more uplink frames. In numerous embodiments, the energy storage capacity can also be indicative of the time taken to discharge the energy storage capacity of the ambient power device.

In further embodiments, the process 500 can determine the TWT service interval aligning with the time required to recharge the energy storage capacity (block 550). In some embodiments, the process 500 can determine the service interval based on the time required by the ambient power device to measure the physical parameters, generate the uplink data, and/or the battery life of the ambient power device. In certain embodiments, the process 500 can determine the service interval such that the ambient power device can operate in the semi-sleep mode during the service interval. In more embodiments, the ambient power device may continue to generate and/or store the uplink data until the next service period starts.

In many more embodiments, the process 500 may generate the TWT schedule indicative of the TWT service period and the TWT service interval (block 560). In some embodiments, the process 500 may optimize the service period and/or the service intervals based on one or more of: change in network conditions, wear and tear in the ambient power device, or usage/activity of the ambient power device, etc. In certain embodiments, the process 500 can thereby modify the TWT schedule or generate a new TWT schedule. In more embodiments, since each ambient power device may have different energy storage capacity and transmission requirements, the process 500 may generate a different TWT schedule for each ambient power device. In some more embodiments, in case of the broadcast TWT schedule, all the ambient power devices in the group may be assigned the broadcast TWT schedule. In that case, in numerous embodiments, the ambient power devices in the group can utilize one or more multiplexing techniques for simultaneous uplink transmissions. In many further embodiments, the process 500 can also utilize ML techniques to further optimize the TWT schedule. In still more embodiments, the process 500 may also continuously monitor the energy consumption and charging status of each ambient power device to dynamically adjust the timing of the semi-sleep mode, transmission mode, or recharging intervals etc.

In many additional embodiments, the process 500 can transmit the schedule data indicative of the TWT schedule to the ambient power device (block 570). In some embodiments, the process 500 may transmit modified schedule data or new schedule data based on the new or modified TWT schedule to the ambient power device. In certain embodiments, the process 500 can transmit broadcast schedule data to the group of ambient power devices. In more embodiments, the process 500 may transmit the schedule data or the broadcast schedule data by way of one or more downlink frames such as but not limited to control frames, trigger frames, management frames, or charging frames etc. for example.

Although a specific embodiment for the process 500 for generating the TWT service period and service interval for carrying out the various steps, processes, methods, and operations described herein is discussed with respect to FIG. 5, any of a variety of systems and/or processes may be utilized in accordance with embodiments of the disclosure. For example, the process 500 may align the TWT schedule with the recharging and transmission times of the ambient power devices. The elements depicted in FIG. 5 may also be interchangeable with other elements of FIGS. 1-4 and FIGS. 6-8 as required to realize a particularly desired embodiment.

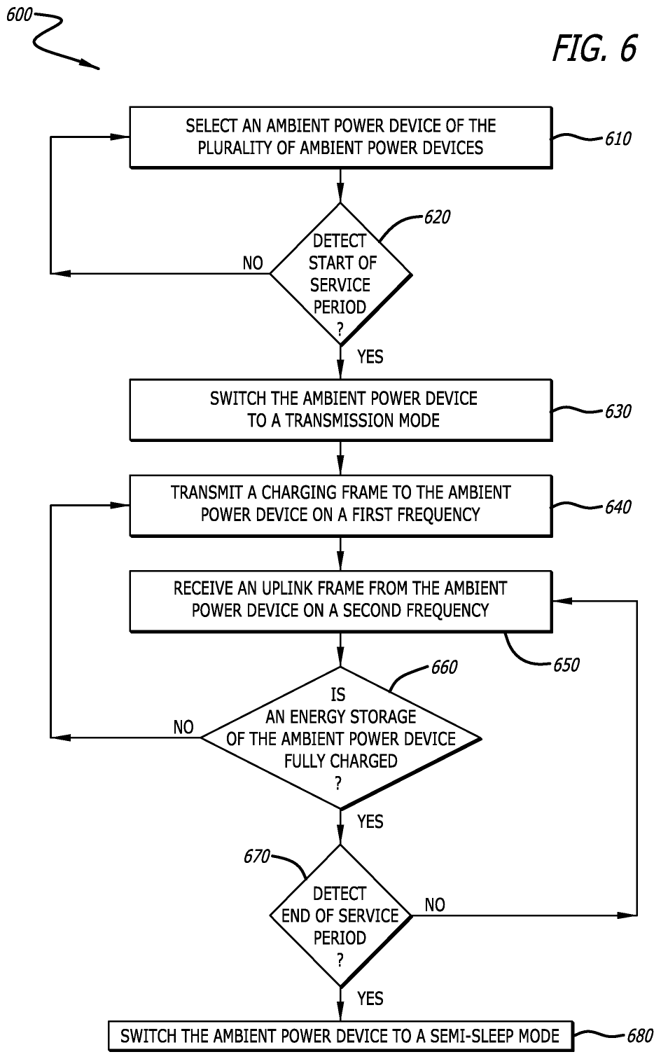

Referring now to FIG. 6, a flowchart depicting a process 600 for transmission and reception of frames, in accordance with various embodiments of the disclosure is shown. In many embodiments, the process 600 can select the ambient power device of the plurality of ambient power devices (block 610). In some embodiments, the process 600 can select one ambient power device at a time based on a predetermined order or based on random selection. In certain embodiments, the process 600 can select more than one ambient power devices simultaneously to transmit the uplink frames by utilizing one or more multiplexing techniques.

In a number of embodiments, the process 600 may check if the service period of the ambient power device has started (block 620). In some embodiments, the process 600 can constantly monitor whether the service periods of the ambient power devices have started and/or ended. In certain embodiments, the service periods of multiple ambient power devices may overlap in time.

In various embodiments, if at block 620, the process 600 determines that the service period has not started, the process 600 may select another ambient power device (block 610). In some embodiments, the process 600 may repeat the block 620 to ensure that all the ambient power devices have been selected and that the service periods of all the ambient power devices have been detected. In certain embodiments, the process 600 can continuously check for the service periods of the ambient power devices.

In additional embodiments, if at block 620, the process 600 determines that the service period has started, the process 600 can switch the ambient power device to the transmission mode (block 630). In some embodiments, the ambient power device may comprise a counter or a timer to trigger switching to the transmission mode. In certain embodiments, the process 600 may transmit a switching signal to the ambient power device to switch the ambient power device to the transmission mode.

In further embodiments, the process 600 may transmit the charging frame to the ambient power device on a first frequency (block 640). In some embodiments, the first frequency may correspond to a first wireless channel or a first RF channel associated with Wi-Fi frequencies in the 2.4 GHZ, 5 GHZ, or 6 GHz ranges, or can also be in Sub-1 GHz range or mmWave range. In certain embodiments, the process 600 can determine a duration of the charging frame, a length of the charging frame, or number of the charging frames based on the device profile of the ambient power device. In more embodiments, the process 600 may transmit the charging frames until the energy storage of the ambient power device is fully recharged.

In many more embodiments, the process 600 can receive the uplink frame from the ambient power device on a second frequency (block 650). In some embodiments, the process 600 may implement off-channel charging of the ambient power device, wherein the first and second frequencies are distinct frequencies, and the second frequency may correspond to a second wireless channel or a second RF channel. In certain embodiments, the process 600 can transmit the charging frame to the ambient power device and receive the uplink frame from the ambient power device simultaneously without causing collisions or interference by utilizing the off-channel charging. In more embodiments, the first and second frequencies may be communicated to the ambient power device by the process 600 at the time of association of the ambient power device with the AP or at any time later. In some more embodiments, the process 600 can assign different frequencies to different ambient power devices. In numerous embodiments, the process 600 may also assign different time slots to different ambient power devices. In still more embodiments, the process 600 may transmit a frequency offset to the ambient power device. In many further embodiments, the ambient power device can utilize the frequency offset to derive the first and second frequencies.

In many additional embodiments, the process 600 may check if the energy storage of the ambient power device is fully charged (block 660). In some embodiments, different ambient power devices may have different energy storage capacities, and hence, may require different time periods to fully recharge. In certain embodiments, the process 600 can adjust the charging time and charging frequency based on the transmission requirements and the energy storage capacities of the ambient power devices. In more embodiments, the ambient power devices can utilize one or more ambient energy sources simultaneously to recharge the energy storage.

In many further embodiments, if at block 660, the process 600 determines that the energy storage of the ambient power device is not fully charged, the process 600 may transmit more charging frames to the ambient power device (block 640). In some embodiments, the process 600 can continuously check a state of charge of the energy storage of the ambient power device. In certain embodiments, the process 600 may continue charging the ambient power device as long as the energy storage of the ambient power device is not fully charged.

If at block 660, the process 600 determines that the energy storage of the ambient power device is fully charged, the process 600 can check if the service period has ended (block 670). In some embodiments, the process 600 may maintain the ambient power device in operational state or in the transmission mode for as long as the service period. In certain embodiments, the process 600 can continuously monitor whether the service period has ended.

If at block 670, the process 600 determines that the service period has not ended, the process 600 can check if there are any more uplink frames to be received from the ambient power device (block 650). In some embodiments, the process 600 may constantly monitor uplink transmissions from the ambient power devices. In certain embodiments, the process 600 can transmit one or more acknowledgement frames to the ambient power device in response to the uplink frames. In more embodiments, the process 600 can transmit a single multi-user bulk acknowledgement frame to multiple ambient power devices.

If at block 670, the process 600 determines that the service period has ended, the process 600 can switch the ambient power device to the semi-sleep mode (block 680). In some embodiments, the ambient power device may continue to generate and/or store the uplink data until the next service period starts. In certain embodiments, the ambient power device may utilize the counter or the timer to trigger switching to the semi-sleep mode. In more embodiments, the ambient power device can switch to the semi-sleep mode when the energy storage is fully recharged.

Although a specific embodiment for the process 600 for transmission and reception of frames for carrying out the various steps, processes, methods, and operations described herein is discussed with respect to FIG. 6, any of a variety of systems and/or processes may be utilized in accordance with embodiments of the disclosure. For example, the process 600 may simultaneously transmit downlink frames and receive uplink frames from the ambient power devices by utilizing the frequency offset. The elements depicted in FIG. 6 may also be interchangeable with other elements of FIGS. 1-5 and FIGS. 7-8 as required to realize a particularly desired embodiment.

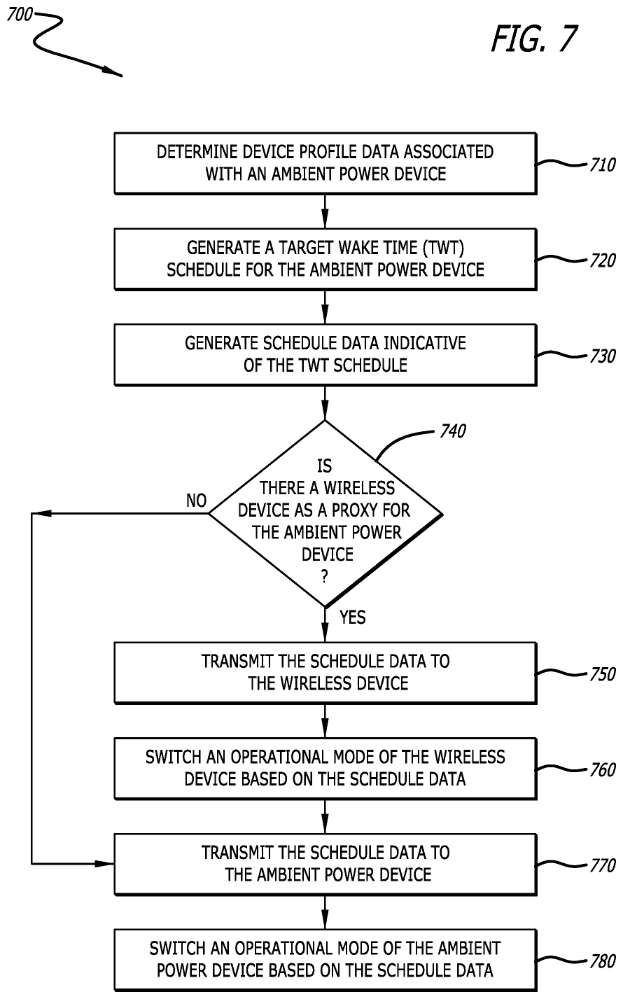

Referring now to FIG. 7, a flowchart depicting a process 700 for aligning the wireless device to the TWT schedule, in accordance with various embodiments of the disclosure is shown. In many embodiments, the process 700 can determine the device profile data associated with the ambient power device (block 710). In some embodiments, the device profile data can include the energy storage capacity and the transmission duration corresponding to the ambient power device. In certain embodiments, the process 700 may receive the device profile data from the ambient power device. In more embodiments, the wireless device can receive the device profile data from the ambient power device and relay the device profile data to the process 700. In some more embodiments, the process 700 may authorize and/or authenticate the ambient power devices based on the device profile data. In numerous embodiments, the process 700 can retrieve the device profile data from one or more databases comprising device information about the ambient power devices. In many further embodiments, the process 700 may discover the device profile data associated with the ambient power devices by employing a combination of one or more of: network scanning, protocol analysis, physical inspection, and database lookup techniques. In still more embodiments, some ambient power devices can periodically or dynamically advertise the device profile data by way of beacon or advertisement messages.

In a number of embodiments, the process 700 can generate the TWT schedule for the ambient power device (block 720). In some embodiments, the process 700 may generate the separate TWT schedule for each ambient power device or the broadcast TWT schedule associated with the group of ambient power devices. In certain embodiments, the process 700 can generate either the TWT schedule or the rTWT schedule. In more embodiments, the process 700 may dynamically modify or change the TWT schedule based on the network conditions.

In various embodiments, the process 700 may generate the schedule data indicative of the TWT schedule (block 730). In some embodiments, the process 700 can transmit one or more downlink frames such as but not limited to the control frames, management frames, trigger frames, or charging frames etc. comprising the schedule data. In certain embodiments, the process 700 may transmit the downlink frames at a different frequency than a frequency utilized for receiving the uplink frames.

In additional embodiments, the process 700 can check whether there is a wireless device that can function as a proxy for the ambient power device (block 740). In some embodiments, there may be one or more ambient power devices in communication with the wireless device, and the wireless device may be in communication with the AP. In certain embodiments, the process 700 can check whether the wireless device can function as relay, proxy, receiver, or energizer for the one or more ambient power devices.

In further embodiments, if at block 740, the process 700 determines that the wireless device can function as the proxy, the process 700 may transmit the schedule data to the wireless device (block 750). In some embodiments, the process 700 can signal the wireless device to enter into a low power mode such as but not limited to the sleep mode during the service interval. In certain embodiments, the wireless device can operate in the functional mode during the service period.

In many more embodiments, the process 700 can switch the operational mode of the wireless device based on the schedule data (block 760). In some embodiments, the wireless device can utilize the counter or the timer to switch between the low power mode and the functional mode. In more embodiments, the operational modes of the wireless device can be synchronized with the operational modes of the ambient power devices.

In further embodiments, after block 760 and/or if at block 740, the process 700 determines that the wireless device cannot function as the proxy, the process 700 may transmit the schedule data to the ambient power devices (block 770). In some embodiments, the schedule data can be transmitted to the wireless device and relayed to the ambient power devices by the wireless device. In more embodiments, the process 700 may transmit the schedule data indicative of the broadcast TWT schedule to the wireless device and the group of ambient power devices in communication with the wireless device. In some more embodiments, the uplink and downlink frames may be relayed by the wireless device during the service period.

In many more embodiments, the process 700 can switch the operational modes of the wireless devices (block 780). In certain embodiments, the process 700 may signal the wireless device and/or the ambient power devices to switch the operational modes. In some embodiments, the wireless device and the ambient power devices may detect the start of the service period and switch the operational modes accordingly.

Although a specific embodiment for the process 700 for aligning the wireless device to the TWT schedule for carrying out the various steps, processes, methods, and operations described herein is discussed with respect to FIG. 7, any of a variety of systems and/or processes may be utilized in accordance with embodiments of the disclosure. For example, the wireless device and the ambient power devices can be synchronized to switch the operational modes. The elements depicted in FIG. 7 may also be interchangeable with other elements of FIGS. 1-6 and FIG. 8 as required to realize a particularly desired embodiment.

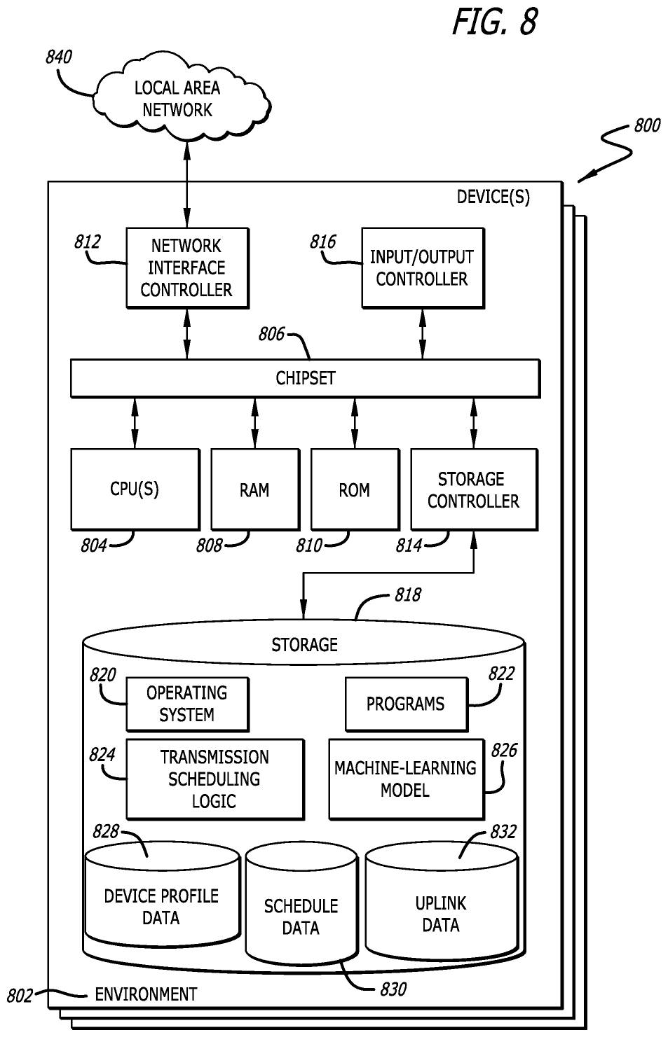

Referring to FIG. 8, a conceptual block diagram of a device 800 suitable for configuration with a transmission scheduling logic, in accordance with various embodiments of the disclosure is shown. The embodiment of the conceptual block diagram depicted in FIG. 8 can illustrate a conventional server, computer, workstation, desktop computer, laptop, tablet, network appliance, e-reader, smartphone, or other computing device, and can be utilized to execute any of the application and/or logic components presented herein. The embodiment of the conceptual block diagram depicted in FIG. 8 can also illustrate an access point, a switch, or a router in accordance with various embodiments of the disclosure. The device 800 may, in many non-limiting examples, correspond to physical devices or to virtual resources described herein.

In many embodiments, the device 800 may include an environment 802 such as a baseboard or “motherboard,” in physical embodiments that can be configured as a printed circuit board with a multitude of components or devices connected by way of a system bus or other electrical communication paths. Conceptually, in virtualized embodiments, the environment 802 may be a virtual environment that encompasses and executes the remaining components and resources of the device 800. In more embodiments, one or more processors 804, such as, but not limited to, central processing units (“CPUs”) can be configured to operate in conjunction with a chipset 806. The processor(s) 804 can be standard programmable CPUs that perform arithmetic and logical operations necessary for the operation of the device 800.

In a number of embodiments, the processor(s) 804 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 806 may provide an interface between the processor(s) 804 and the remainder of the components and devices within the environment 802. The chipset 806 can provide an interface to a random-access memory (“RAM”) 808, which can be used as the main memory in the device 800 in some embodiments. The chipset 806 can further be configured to provide an interface to a computer-readable storage medium such as a read-only memory (“ROM”) 810 or non-volatile RAM (“NVRAM”) for storing basic routines that can help with various tasks such as, but not limited to, starting up the device 800 and/or transferring information between the various components and devices. The ROM 810 or NVRAM can also store other application components necessary for the operation of the device 800 in accordance with various embodiments described herein.

Additional embodiments of the device 800 can be configured to operate in a networked environment using logical connections to remote computing devices and computer systems through a network, such as the network 840. The chipset 806 can include functionality for providing network connectivity through a network interface card (“NIC”) 812, which may comprise a gigabit Ethernet adapter or similar component. The NIC 812 can be capable of connecting the device 800 to other devices over the network 840. It is contemplated that multiple NICs 812 may be present in the device 800, connecting the device to other types of networks and remote systems.

In further embodiments, the device 800 can be connected to a storage 818 that provides non-volatile storage for data accessible by the device 800. The storage 818 can, for instance, store an operating system 820, applications 822, device profile data 828, schedule data 830, and uplink data 832 which are described in greater detail below. The storage 818 can be connected to the environment 802 through a storage controller 814 connected to the chipset 806. In certain embodiments, the storage 818 can consist of one or more physical storage units. The storage controller 814 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units. The device profile data 828 can store the energy profile and the transmission profile of the ambient power devices and/or the wireless device. The schedule data 830 may store the TWT schedule or the broadcast TWT schedule including the service period and/or the service interval. The uplink data 832 can store the uplink data received by way of the uplink frames. The uplink data can be indicative of the values of the physical parameters measured by the ambient power devices.

The device 800 can store data within the storage 818 by transforming the physical state of the physical storage units to reflect the information being stored. The specific transformation of physical state can depend on various factors. Examples of such factors can include, but are not limited to, the technology used to implement the physical storage units, whether the storage 818 is characterized as primary or secondary storage, and the like.

In many more embodiments, the device 800 can store information within the storage 818 by issuing instructions through the storage controller 814 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 800 can further read or access information from the storage 818 by detecting the physical states or characteristics of one or more particular locations within the physical storage units.

In addition to the storage 818 described above, the device 800 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 800. In some examples, the operations performed by a cloud computing network, and or any components included therein, may be supported by one or more devices similar to device 800. Stated otherwise, some or all of the operations performed by the cloud computing network, and or any components included therein, may be performed by one or more devices 800 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 818 can store an operating system 820 utilized to control the operation of the device 800. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 818 can store other system or application programs and data utilized by the device 800.

In many additional embodiments, the storage 818 or other computer-readable storage media is encoded with computer-executable instructions which, when loaded into the device 800, may transform it from a general-purpose computing system into a special-purpose computer capable of implementing the embodiments described herein. These computer-executable instructions may be stored as application 822 and transform the device 800 by specifying how the processor(s) 804 can transition between states, as described above. In some embodiments, the device 800 has access to computer-readable storage media storing computer-executable instructions which, when executed by the device 800, perform the various processes described above with regard to FIGS. 1-7. In certain embodiments, the device 800 can also include computer-readable storage media having instructions stored thereupon for performing any of the other computer-implemented operations described herein.

In many further embodiments, the device 800 may include a transmission scheduling logic 824. The transmission scheduling logic 824 can be configured to perform one or more of the various steps, processes, operations, and/or other methods that are described above. Often, the transmission scheduling logic 824 can be a set of instructions stored within a non-volatile memory that, when executed by the processor(s)/controller(s) 804 can carry out these steps, etc. In some embodiments, the transmission scheduling logic 824 may be a client application that resides on a network-connected device, such as, but not limited to, a server, switch, personal or mobile computing device in a single or distributed arrangement. The transmission scheduling logic 824 can generate the TWT schedules for the ambient power devices and transmit the schedule data indicative of the TWT schedules to the ambient power devices.

In still further embodiments, the device 800 can also include one or more input/output controllers 816 for receiving and processing input from a number of input devices, such as a keyboard, a mouse, a touchpad, a touch screen, an electronic stylus, or other type of input device. Similarly, an input/output controller 816 can be configured to provide output to a display, such as a computer monitor, a flat panel display, a digital projector, a printer, or other type of output device. Those skilled in the art will recognize that the device 800 might not include all of the components shown in FIG. 8 and can include other components that are not explicitly shown in FIG. 8 or might utilize an architecture completely different than that shown in FIG. 8.

As described above, the device 800 may support a virtualization layer, such as one or more virtual resources executing on the device 800. In some examples, the virtualization layer may be supported by a hypervisor that provides one or more virtual machines running on the device 900 to perform functions described herein. The virtualization layer may generally support a virtual resource that performs at least a portion of the techniques described herein.

Finally, in numerous additional embodiments, data may be processed into a format usable by a machine-learning model 826 (e.g., feature vectors), and or other pre-processing techniques. The machine-learning (“ML”) model 826 may be any type of ML model, such as supervised models, reinforcement models, and/or unsupervised models. The ML model 826 may include one or more of linear regression models, logistic regression models, decision trees, Naïve Bayes models, neural networks, k-means cluster models, random forest models, and/or other types of ML models 826.

The ML model(s) 826 can be configured to generate inferences to make predictions or draw conclusions from data. An inference can be considered the output of a process of applying a model to new data. This can occur by learning from at least the device profile data 828, the schedule data 830, and the uplink data 832 and use that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 826 may be generated by human/administrator verifications or may compare predicted outcomes with actual outcomes.

Although a specific embodiment for the device 800 suitable for configuration with the transmission scheduling logic for carrying out the various steps, processes, methods, and operations described herein is discussed with respect to FIG. 8, any of a variety of systems and/or processes may be utilized in accordance with embodiments of the disclosure. For example, the device 800 may be in a virtual environment such as a cloud-based network administration suite, or it may be distributed across a variety of network devices or switches. The elements depicted in FIG. 8 may also be interchangeable with other elements of FIGS. 1-7 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A device, comprising:
a processor;
a memory communicatively coupled to the processor; and
a transmission scheduling logic, configured to:
detect a plurality of ambient power devices;
determine device profile data associated with an ambient power device of the plurality of ambient power devices;
generate schedule data based on the device profile data; and
transmit the schedule data to the ambient power device.

2. The device of claim 1, wherein the schedule data is indicative of a Target Wake Time (TWT) schedule associated with the ambient power device.

3. The device of claim 2, wherein the device profile data is indicative of at least one of:
an energy storage capacity of the ambient power device, or
a transmission duration associated with the ambient power device.

4. The device of claim 3, wherein the transmission scheduling logic is further configured to determine:
a service period of the TWT schedule based on the transmission duration; and
a service interval of the TWT schedule based on the energy storage capacity.

5. The device of claim 4, wherein the ambient power device operates in a semi-sleep mode during the service interval and in a transmission mode during the service period.

6. The device of claim 5, wherein the transmission scheduling logic is further configured to:
generate at least one control frame based on the schedule data; and
transmit the at least one control frame to the ambient power device during the service period on a first Radio Frequency (RF) channel.

7. The device of claim 6, wherein the transmission scheduling logic is further configured to receive, on a second RF channel, at least one uplink frame indicative of uplink data from the ambient power device.

8. The device of claim 7, wherein an energy storage of the ambient power device is recharged based on the at least one control frame.

9. The device of claim 8, wherein the energy storage is utilized to generate the uplink data.

10. The device of claim 5, wherein the transmission scheduling logic is further configured to:
identify a wireless device in communication with the ambient power device; and
transmit the schedule data to the wireless device.

11. The device of claim 10, wherein the wireless device operates in a power saving mode during the service interval and in an operational mode during the service period.

12. The device of claim 11, wherein the transmission scheduling logic is further configured to receive, from the wireless device, at least one uplink frame associated with the ambient power device during the service period.

13. A method, comprising:
detecting a plurality of ambient power devices;
determining device profile data associated with a set of ambient power devices of the plurality of ambient power devices;
generating schedule data based on the device profile data; and
transmitting the schedule data to the set of ambient power devices.

14. The method of claim 13, wherein the schedule data is indicative of a broadcast Target Wake Time (TWT) schedule associated with the set of ambient power devices.

15. The method of claim 14, wherein the device profile data is indicative of at least one of:
one or more energy storage capacities of the set of ambient power devices, or
one or more transmission durations associated with the set of ambient power devices.

16. The method of claim 15, further comprising:
determining a service period of the broadcast TWT schedule based on the one or more transmission durations; and
a service interval of the broadcast TWT schedule based on the one or more energy storage capacities.

17. The method of claim 16, further comprising charging the set of ambient power devices during the service period.

18. A device, comprising:
a processor;
a memory communicatively coupled to the processor; and
a transmission scheduling logic, configured to:
receive schedule data indicative of a service period and a service interval;
receive, on a first wireless channel, a charging frame during the service period;
recharge an energy storage based on the charging frame; and
transmit, on a second wireless channel, an uplink frame during the service period.

19. The device of claim 18, wherein the transmission scheduling logic is further configured to:
operate in a semi-sleep mode during the service interval; and
operate in a transmission mode during the service period.

20. The device of claim 19, wherein the transmission scheduling logic is further configured to generate uplink data associated with the uplink frame during the service interval.
